(19) United States
(12) Patent Application Publication
(10) Pub. No.: US 2022/0368203 A1
(43) Pub. Date: Nov. 17, 2022

(54) MOTOR AND MOTOR UNIT

(71) Applicant: NIDEC CORPORATION, Kyoto (JP)

(72) Inventor: Kuniaki TANAKA, Kyoto (JP)

(21) Appl. No.: 17/623,220

(22) PCT Filed: Jul. 1, 2020
(86) PCT No.: PCT/JP2020/025778

§ 371 Date: Dec. 27, 2021

(30) Foreign Application Priority Data
Jul. 1, 2019 (JP) 2019-123200

(51) Int. Cl. H02K 29/03; H02K 1/276; H02K 7/116

(52) U.S. Cl. CPC H02K 29/03; H02K 1/276; H02K 7/116; H02K 2201/06

(57) ABSTRACT

A motor includes a rotor with a rotor core formed of stacked electromagnetic steel sheets and rotor magnets, and a stator surrounding the rotor. The rotor core includes pairs of magnet insertion hole portions with an opposing distance sequentially increasing radially outwardly. The rotor magnets are in the magnet insertion hole portions. The rotor core includes first blocks arranged by dividing the rotor core into two blocks in the axial direction, and a second block between the two first blocks. An angle formed by the rotor magnets in the pair of magnet insertion hole portions in the first block is a first magnet opening angle θ1. An angle formed by the rotor magnets in the pair of magnet insertion hole portions in the second block is a second magnet opening angle θ2. The second magnet opening angle θ2 is larger than the first magnet opening angle θ1.

### CROSS-REFERENCE TO RELATED APPLICATIONS

This is the U.S. national stage of application No. PCT/JP2020/025778, filed on Jul. 1, 2020, and priority under 35 U.S.C. § 119(a) and 35 U.S.C. § 365(b) is claimed from Japanese Patent Application No. 2019-123200, filed on Jul. 1, 2019.

### FIELD OF THE INVENTION

The present invention relates to a motor and a motor unit including the motor. The present application claims priority based on Japanese Patent Application No. 2019-123200 filed in Japan on Jul. 1, 2019, the contents of which are incorporated herein by reference.

### BACKGROUND

In recent years, motors mounted on hybrid vehicles and electric vehicles have been actively developed. Such a motor includes a rotor, a stator that surrounds the rotor from an outside in a radial direction, and a housing that accommodates the rotor and the stator.

A rotor iron core (rotor core) formed by stacking electromagnetic steel sheets is conventionally known. The conventional rotating iron core (rotor core) is divided into a plurality of blocks having equal thickness dimensions, and the plurality of blocks are stacked in an axial direction. A plurality of cavities are formed in each block, and permanent magnets (rotor magnets) are inserted into cavities arranged in a V shape among cavities.

In the electric vehicles or the hybrid vehicles, noise reduction in a vehicle interior is more required. It is known that torque fluctuations such as cogging torque and torque ripple of the motor lead to vibration and noise in the vehicle interior. The conventional rotor has a structure in which the rotor is divided into two blocks and permanent magnets (rotor magnets) are shifted in a circumferential direction between the two blocks. The arrangement of the permanent magnets (rotor magnets) of the two blocks is the same, and torque fluctuations are likely to occur.

### SUMMARY

A motor according to an embodiment of the present invention includes a rotor that includes a rotor core formed by stacking a plurality of electromagnetic steel sheets and a plurality of rotor magnets, and is rotatable about a center axis extending in an upper-lower direction, and a stator that surrounds the rotor from an outside of the center axis in a radial direction. The rotor core includes a plurality of pairs of magnet insertion hole portions arranged such that an opposing distance sequentially increases toward the outside in the radial direction as viewed in an axial direction. The plurality of rotor magnets are positioned in the magnet insertion hole portions. The rotor core includes first blocks arranged by dividing the rotor core into two blocks in the axial direction, and a second block arranged between the two first blocks. When an angle formed by the rotor magnets in the pair of magnet insertion hole portions in the first block is defined as a first magnet opening angle θ1 and an angle formed by the rotor magnets in the pair of magnet insertion hole portions in the second block is defined as a second magnet opening angle θ2, the second magnet opening angle θ2 is larger than the first magnet opening angle θ1.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a conceptual diagram schematically illustrating a motor unit according to an embodiment;

FIG. 2 is a perspective view of the motor unit according to the embodiment;

FIG. 3 is an external view of a rotor according to the embodiment;

FIG. 4 is a cross-sectional view taken along a line A-A of a rotor core according to the embodiment;

FIG. 5 is a cross-sectional view taken along a line B-B of the rotor core according to the embodiment;

FIG. 6 is a cross-sectional view taken along a line C-C of the rotor core according to the embodiment;

FIG. 7 is a graph showing a relationship between a first magnet opening angle θ1 and a torque ripple in the embodiment;

FIG. 8 is a graph showing a relationship between a skew angle α1 and a torque ripple in one embodiment;

FIG. 9 is a table showing a change in torque ripple when the first magnet opening angle θ1 and the second magnet opening angle θ2 are changed when the skew angle α1 is 1° in the embodiment;

FIG. 10 is a table showing a change in torque ripple when the first magnet opening angle θ1 and the second magnet opening angle θ2 are changed when the skew angle α1 is 2° in the embodiment;

FIG. 11 is a table showing a change in torque ripple when the first magnet opening angle θ1 and the second magnet opening angle θ2 are changed when the skew angle α1 is 3° in the embodiment;

FIG. 12 is an external view of a rotor according to another embodiment; and

FIG. 13 is a table showing a change in torque ripple when the first magnet opening angle θ1 and the second magnet opening angle θ2 are changed when the skew angle α1 is 3.75° in another embodiment.

### DETAILED DESCRIPTION

Hereinafter, a motor and a motor unit according to an embodiment of the present invention will be described with reference to the drawings. Note that, the scope of the present invention is not limited to the embodiment to be described below, but includes any modification thereof within the scope of the technical idea of the present invention. In addition, there is a case where scales, numbers, and the like of structures illustrated in the following drawings may differ from those of actual structures, for the sake of easier understanding of the structures.

The following description will be made with a vertical direction being defined based on a positional relationship in a case where a motor unit 10 according to the embodiment illustrated in the drawings is mounted on a vehicle positioned on a horizontal road surface. In addition, in the drawings, an XYZ coordinate system is shown appropriately as a three-dimensional orthogonal coordinate system. In the XYZ coordinate system, a Z-axis direction is a vertical direction. A +Z side is an upper side in the vertical direction, and a −Z side is a lower side in the vertical direction. In the following description, the upper side and the lower side in the vertical direction will be referred to simply as the “upper side” and the “lower side”, respectively. An X-axis direction corresponds to a front-rear direction of the vehicle on which the motor unit 10 is mounted, and is a direction orthogonal to the Z-axis direction. In the present embodiment, a +X side is a front side of the vehicle, and a −X side is a rear side of the vehicle. A Y-axis direction is a direction perpendicular to both the X-axis direction and the Z-axis direction, and is a left-right direction of the vehicle (vehicle width direction). In the present embodiment, a +Y side is a left side of the vehicle and is one side in an axial direction of a motor axis J1. In addition, in the present embodiment, a −Y side is a right side of the vehicle and the other side in the axial direction of the motor axis J1.

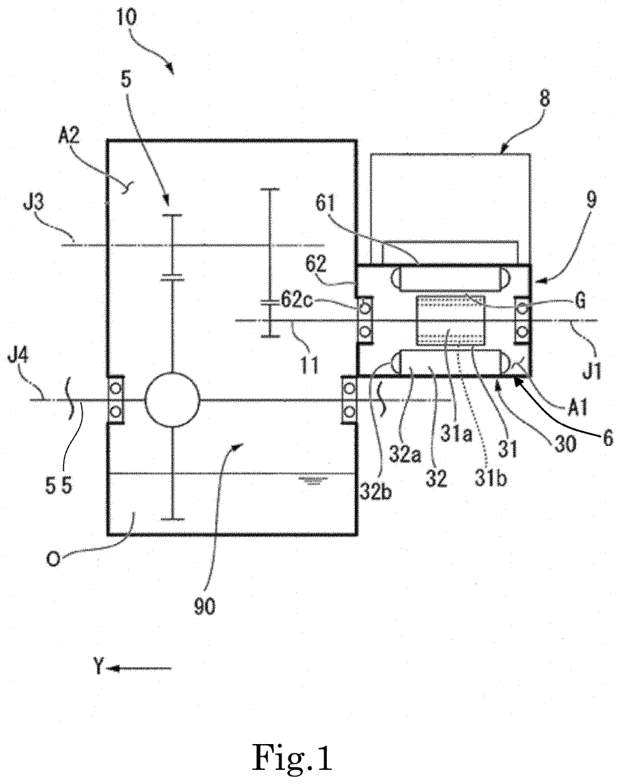

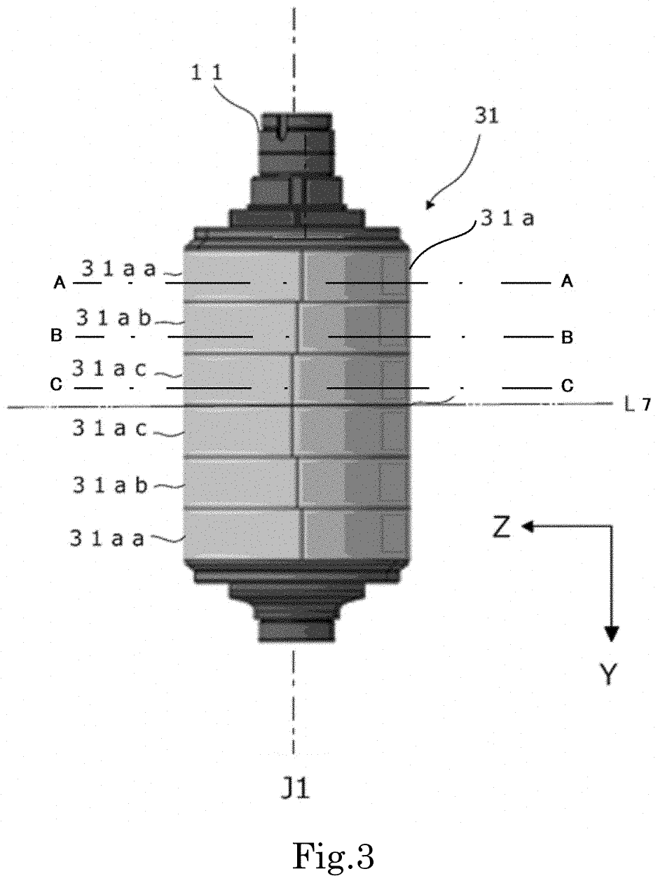

FIG. 1 is a conceptual diagram of the motor unit 10 according to the embodiment. Note that, the motor axis (center axis) J1, a counter axis J3, and an output axis J4, which will be described later, are virtual axes that are not actually present. In addition, a center line L0, a center line L1, a center line L2, an axis L3, an axis L4, an axis L5, an axis L6, and an imaginary line L7 illustrated in FIGS. 3 to 6 are virtual lines that are not actually present.

The motor unit 10 is mounted on a vehicle, and drives the vehicle by rotating wheels mounted on the vehicle. For example, the motor unit 10 is mounted on an electric vehicle (EV). Note that, the motor unit 10 only has to be mounted on a vehicle including a motor as a power source, such as a hybrid electric car (HEV) or a plug-in hybrid electric car (PHV).

As illustrated in FIG. 1, the motor unit 10 includes a motor 9, a transmission mechanism 5 (transaxle), an inverter unit 8.

The motor 9 is an electric generator having both a function as an electric motor and a function as a generator. The motor 9 mainly functions as an electric motor to drive the vehicle, and functions as a generator during regeneration. The motor 9 is an inner rotor type motor.

The motor 9 includes a motor body 30 and a housing 6. The motor body 30 includes a rotor 31 and a stator 32 that surrounds the rotor 31 from an outside of the motor axis (center axis) J1 in a radial direction. Note that, in the following description, a radial direction with the motor axis J1 as a center is simply referred to as a “radial direction”, and a circumferential direction with the motor axis J1 as a center, that is, a direction around the motor axis J1 is simply referred to as a “circumferential direction”.

The rotor 31 is rotatable about the motor axis J1, which extends in a horizontal direction. The rotor 31 rotates by a power being supplied from a battery (not shown) to the stator 32. The rotor 31 is connected to a motor drive shaft 11 of the transmission mechanism 5 and rotates the motor drive shaft 11. As a result, a torque of the rotor 31 is transmitted to the transmission mechanism 5.

The rotor 31 includes a rotor core 31a and rotor magnets 31b. The rotor core 31a is a columnar body extending along the axial direction. The rotor magnets 31b are fixed to the rotor core 31a.

The stator 32 surrounds the rotor 31 from the outside in the radial direction. The stator 32 includes a stator core 32a, a coil 32b, and an insulating member (not illustrated) interposed between the stator core 32a and the coil 32b.

The stator core 32a is fixed to the housing 6 as will be described later. The stator core 32a includes a plurality of magnetic pole teeth (not illustrated) from an inner peripheral surface of an annular yoke to an inside in the radial direction. A coil wire is wound between the magnetic pole teeth. The coil wire wound around the magnetic pole teeth constitutes the coil 32b. That is, the coil 32b is attached to the stator core 32a. Note that, in the present invention, the stator 32 has a plurality of slots (not illustrated) into which the coil 32b is inserted. 48 slots are formed in the circumferential direction.

The inverter unit 8 is fixed to an outer surface of the housing 6. The inverter unit 8 supplies an alternating current to the motor body 30.

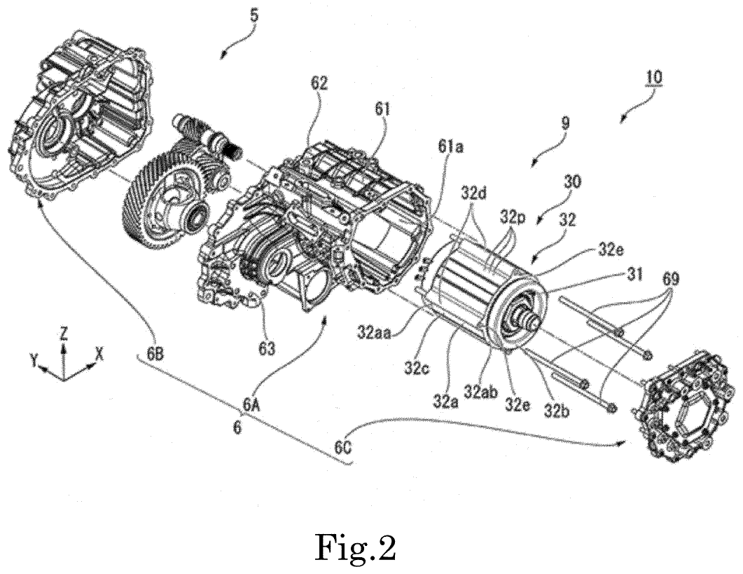

FIG. 2 is an exploded view of the motor unit 10. Note that, in FIG. 2, illustration of some members such as the inverter unit 8 is omitted.

The stator core 32a includes a plurality of electromagnetic steel sheets 32p stacked along the axial direction. The plurality of electromagnetic steel sheets 32p are connected to each other by a method such as welding or caulking.

A plurality of fastening portions 32d are provided on an outer peripheral surface 32c of the stator core 32a. That is, the stator 32 includes the plurality of fastening portions 32d. The fastening portion 32d protrudes from the outer peripheral surface 32c of the stator 32 to the outside in the radial direction. The fastening portion 32d extends in a rib shape along the axial direction. In the present embodiment, four fastening portions 32d are provided on the outer peripheral surface 32c of the stator 32. The four fastening portions 32d are arranged at equal intervals along the circumferential direction.

Through-holes 32e extending along the axial direction are provided in the fastening portions 32d. That is, a plurality of through-holes 32e penetrating along the axial direction are provided in the stator core 32a. In the present embodiment, one through-hole 32e is provided in one fastening portion 32d. The through-hole 32e is opened at an end face (first end face 32aa) on one side of the stator core 32a in the axial direction and an end face (second end face 32ab) on the other side in the axial direction. Fixing bolts 69 for fixing the stator 32 to the housing 6 are inserted into the through-holes 32e.

As illustrated in FIG. 1, the rotor 31 and the stator 32 face each other in the radial direction with an air gap G interposed therebetween. The air gap G is a substantially uniform gap along the axial direction. In addition, the air gap G is a substantially uniform gap along the circumferential direction.

The transmission mechanism 5 transmits power of the motor body 30 to output the power from an output shaft 55. The transmission mechanism 5 incorporates a plurality of mechanisms responsible for power transmission between a drive source and a driven device.

The housing 6 accommodates the motor body 30 and the transmission mechanism 5. The housing 6 is made of, for example, an aluminum alloy manufactured by die casting. A motor chamber A1 that accommodates the motor body 30 and a gear chamber A2 that accommodates the transmission mechanism 5 are provided inside the housing 6. Oil 0 is accumulated inside the housing 6. The oil 0 is used for lubricating the transmission mechanism 5, and is used for cooling the motor body 30.

As shown in FIG. 2, the housing 6 includes a first housing member 6A, a second housing member 6B, and a blockage unit 6C.

The first housing member 6A includes a tubular portion 61, a bottom portion 62, and a side plate portion 63. That is, the housing 6 includes the tubular portion 61, the bottom portion 62, and the side plate portion 63.

The tubular portion 61 has a tubular shape extending in the axial direction. The tubular portion 61 surrounds the motor body 30 from the outside in the radial direction. As a result, the tubular portion 61 accommodates the motor body 30. That is, the motor chamber A1 is formed in a space inside the tubular portion 61. The tubular portion 61 has an inner peripheral surface 61a facing the inside in the radial direction.

The rotor core 31a will be described with reference to FIGS. 2 to 6. The rotor core 31a is obtained by stacking a plurality of electromagnetic steel sheets. The rotor core 31a is divided into six blocks (first block 31aa, first block 31aa, second block 31ab, second block 31ab, third block 31ac, and third block 31ac) having equal thickness dimensions, and the first block 31aa, the second block 31ab, the third block 31ac, the third block 31ac, the second block 31ab, and the first block 31aa are stacked in this order from the −Y side. That is, the rotor core 31a has a shape inverted around the imaginary line L7. As a result, even in the case of a skew structure in which the blocks are arranged at a predetermined angle in the circumferential direction, since upper and lower magnetic characteristics are the same around the imaginary line L7, it is possible to prevent deformation of the rotor core 31a during rotation. In addition, the rotor core 31a has a so-called skew structure, and thus, it is possible to reduce the pulsation of the torque when the rotor 31 rotates.

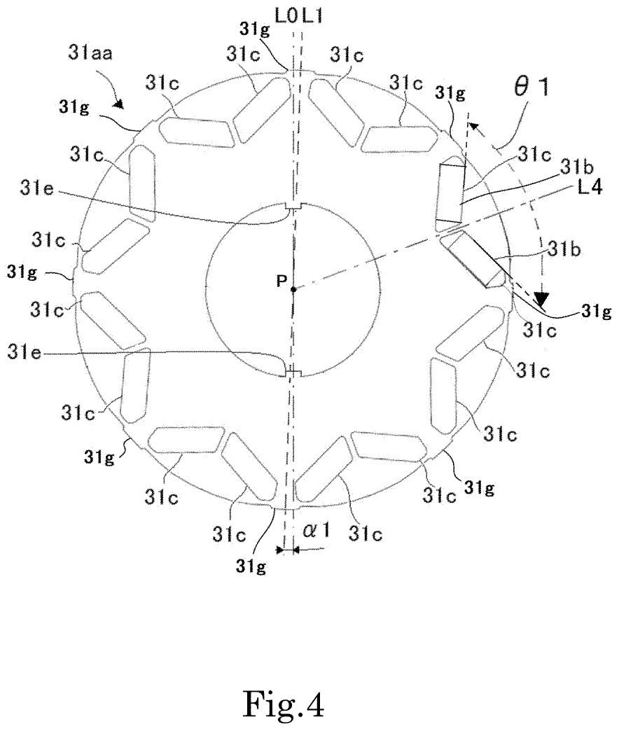

FIG. 4 is a cross-sectional view taken along a line A-A of the rotor core 31a in FIG. 3. A cross section of the first block 31aa will be described with reference to FIG. 4. In the first block 31aa, 16 magnet insertion hole portions 31c are provided, and two magnet insertion hole portions 31c form a pair. The pair of magnet insertion hole portions 31c are formed at equal intervals in the circumferential direction. That is, eight pairs of magnet insertion hole portions 31c are provided in the first block 31aa. The eight pairs of magnet insertion hole portions 31c are formed at equal intervals by 45 degrees in the circumferential direction.

Each magnet insertion hole portion 31c has a substantially parallelogram shape in plan view. An opposing distance of long sides of the pair of magnet insertion hole portions 31c sequentially increases toward the outside in the radial direction in plan view. Specifically, the pair of magnet insertion hole portions 31c are provided line-symmetrically about the virtual axis L4 extending in the radial direction from the center. The magnet insertion hole portion 31c is gradually inclined to the outside in the radial direction as a distance from the virtual axis L4 increases in the circumferential direction. Accordingly, the pair of magnet insertion hole portions 31c have a V shape as viewed from the axial direction.

The rotor magnets 31b are inserted into the magnet insertion hole portions 31c, respectively. The rotor magnets 31b are fixed to the first block 31aa by, for example, molding with resin. In the present embodiment, since there are eight pairs of magnet insertion hole portions 31c, there are also eight pairs of rotor magnets 31b. The eight pairs of rotor magnets 31b are arranged at equal intervals by 45 degrees in the circumferential direction.

In FIG. 4, the rotor magnets 31b are inserted into only some of the pair of magnet insertion hole portions 31c, but actually, the rotor magnets 31b are inserted into all the magnet insertion hole portions 31c. In the pair of magnet insertion hole portions 31c, magnets having different polarities are inserted into the pair of magnet insertion hole portions 31c adjacent to each other in the circumferential direction. That is, rod-shaped magnets in which N poles and S poles are formed in the radial direction are alternately inserted into the pair of magnet insertion hole portions 31c. For example, rod-shaped magnets in which N poles are formed on the outside in the radial direction and S poles are formed on the inside in the radial direction are inserted into the pair of magnet insertion hole portions 31c through which the virtual axis L4 in FIG. 4 passes. Rod-shaped magnets in which S poles are formed on the outside in the radial direction and N poles are formed on the inside in the radial direction is inserted into the pair of magnet insertion hole portions 31c on both sides of the pair of magnet insertion hole portions 31c through which the virtual axis L4 in FIG. 4 passes.

Here, an angle formed by the pair of rotor magnets 31b arranged in the V shape is defined as a first magnet opening angle θ1. That is, the first magnet opening angle θ1 refers to an angle formed by long sides (long sides on the outside in the radial direction) of the pair of rotor magnets 31b inserted into the pair of magnet insertion hole portions 31c.

Protrusion portions 31g are formed on an outer peripheral surface of the first block 31aa. A plurality of protrusion portions 31g are formed on the outside of the magnet insertion hole portions 31c in the radial direction. In the present embodiment, the protrusion portions 31g are provided at eight positions, and are provided between the pairs of magnet insertion hole portions 31c adjacent to each other. In addition, the eight protrusion portions 31g are provided at equal angular intervals in the circumferential direction.

Keys 31e protruding inward are provided on an inner peripheral surface of the first block 31aa. The key 31e has a rectangular shape. A plurality of keys 31e are provided. In the present embodiment, the keys 31e are provided at two positions. The two keys 31e are provided at equal angular intervals in the circumferential direction. In the first block 31aa, the center line L0, which passes through a center in a tangential direction of the two keys 31e and an axis P, and the center line L1, which passes through centers between the pair of magnet insertion hole portions 31c adjacent to the center line L0 and the pair of magnet insertion hole portions 31c adjacent to the pair of magnet insertion hole portions 31c adjacent to the center line L0 and passes through the axis P, are formed to be shifted in the circumferential direction at an angle of α1.

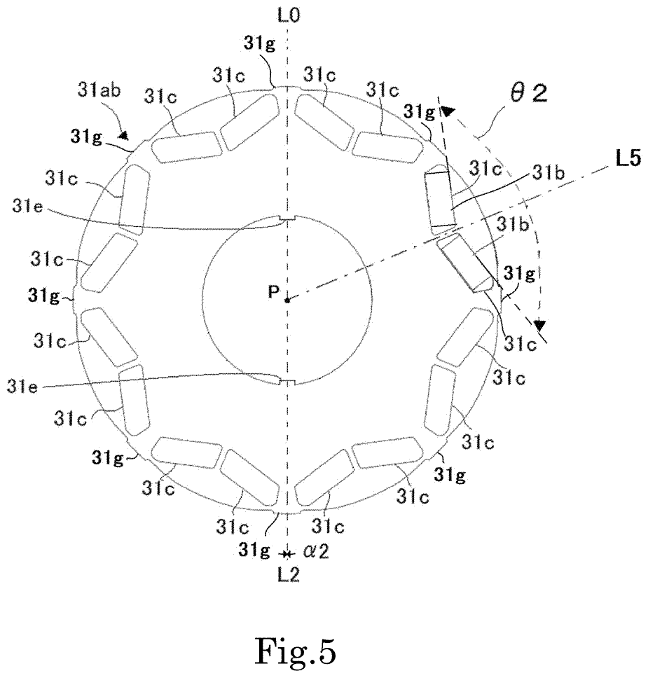

FIG. 5 is a cross-sectional view taken along a line B-B of the rotor core 31a in FIG. 3. A cross section of the second block 31ab will be described with reference to FIG. 5. In the second block 31ab, 16 magnet insertion hole portions 31c are provided, and two magnet insertion hole portions 31c form a pair. The pair of magnet insertion hole portions 31c are formed at equal intervals in the circumferential direction. That is, eight pairs of magnet insertion hole portions 31c are provided in the second block 31ab. The eight pairs of magnet insertion hole portions 31c are formed at equal intervals by 45 degrees in the circumferential direction.

Each magnet insertion hole portion 31c has a substantially parallelogram shape in plan view. An opposing distance of long sides of the pair of magnet insertion hole portions 31c sequentially increases toward the radial direction in plan view. Specifically, the pair of magnet insertion hole portions 31c are provided line-symmetrically about the virtual axis L5 extending in the radial direction from the center. The magnet insertion hole portion 31c is gradually inclined to the outside in the radial direction as a distance from the virtual axis L5 increases in the circumferential direction. Accordingly, the pair of magnet insertion hole portions 31c have a V shape as viewed from the axial direction.

The rotor magnets 31b are inserted into the magnet insertion hole portions 31c, respectively. The rotor magnets 31b are fixed to the second block 31ab by, for example, molding with resin. In the present embodiment, since there are eight pairs of magnet insertion hole portions 31c, there are also eight pairs of rotor magnets 31b. The eight pairs of rotor magnets 31b are arranged at equal intervals by 45 degrees in the circumferential direction.

In FIG. 5, the rotor magnets 31b are inserted into only some of the pairs of magnet insertion hole portions 31c, but the rotor magnets 31b are inserted into all the magnet insertion hole portions 31c. In the pair of magnet insertion hole portions 31c, magnets having different polarities are inserted into the pair of magnet insertion hole portions 31c adjacent to each other in the circumferential direction. That is, rod-shaped magnets in which N poles and S poles are formed in the radial direction are alternately inserted into the pair of magnet insertion hole portions 31c. For example, rod-shaped magnets in which N poles are formed on the outside in the radial direction and S poles are formed on the inside in the radial direction are inserted into the pair of magnet insertion hole portions 31c through which the virtual axis L5 in FIG. 5 passes. Rod-shaped magnets in which S poles are formed on the outside in the radial direction and N poles are formed on the inside in the radial direction are inserted into the pair of magnet insertion hole portions 31c on both sides of the pair of magnet insertion hole portions 31c through which the virtual axis L5 in FIG. 5 passes.

Here, an angle formed by the pair of rotor magnets 31b arranged in the V shape is defined as a second magnet opening angle θ2. That is, the second magnet opening angle θ2 refers to an angle formed by long sides (long sides on the outside in the radial direction) of the pair of rotor magnets 31b inserted into the pair of magnet insertion hole portions 31c.

Protrusion portions 31g are formed on an outer peripheral surface of the second block 31ab. A plurality of protrusion portions 31g are formed on the outside of the magnet insertion hole portions 31c in the radial direction. In the present embodiment, the protrusion portions 31g are provided at eight positions, and are provided between the pairs of magnet insertion hole portions 31c adjacent to each other. In addition, the eight protrusion portions 31g are provided at equal angular intervals in the circumferential direction.

Keys 31e protruding inward are provided on an inner peripheral surface of the second block 31ab. The key 31e has a rectangular shape. A plurality of keys 31e are provided. In the present embodiment, the keys 31e are provided at two positions. The two keys 31e are provided at equal angular intervals in the circumferential direction. In the second block 31ab, the center line L0, which passes through a center in a tangential direction of the two keys 31e and the axis P, and the center line L2, which passes through centers between the pair of magnet insertion hole portions 31c adjacent to the center line L0 and the pair of magnet insertion hole portions 31c adjacent to the pair of magnet insertion hole portions 31c adjacent to the center line L0 and passes through the axis P coincide. That is, in the second block 31ab, an angle α2 formed by the center line L0, which passes through a center in a tangential direction of the two keys 31e and the axis P, and the center line L2, which passes through centers between the pair of magnet insertion hole portions 31c adjacent to the center line L0 and the pair of magnet insertion hole portions 31c adjacent to the pair of magnet insertion hole portions 31c adjacent to the center line L0 and which passes through the axis P is 0°.

That is, the center line L1 of the first block 31aa and the center line L2 of the second block 31ab are formed to be shifted in the circumferential direction at an angle α1. That is, the first block 31aa and the second block 31ab have a so-called skew structure in which these blocks are integrally assembled in a state of being shifted at an angle of α1 in the circumferential direction.

In the first block 31aa, eight pairs of magnet insertion hole portions 31c are formed at equal intervals by 45 degrees in the circumferential direction. In addition, in the second block 31ab, eight pairs of magnet insertion hole portions 31c are also formed at equal intervals by 45 degrees in the circumferential direction. Since the first block 31aa and the second block 31ab have a so-called skew structure shifted in the circumferential direction, the virtual axis L4 of the first block 31aa and the virtual axis L5 of the second block are also formed to be shifted in the circumferential direction at an angle of α1 degrees such that the center line L1 of the first block 31aa and the center line L2 of the second block 31ab are formed to be shifted in the circumferential direction at an angle of α1.

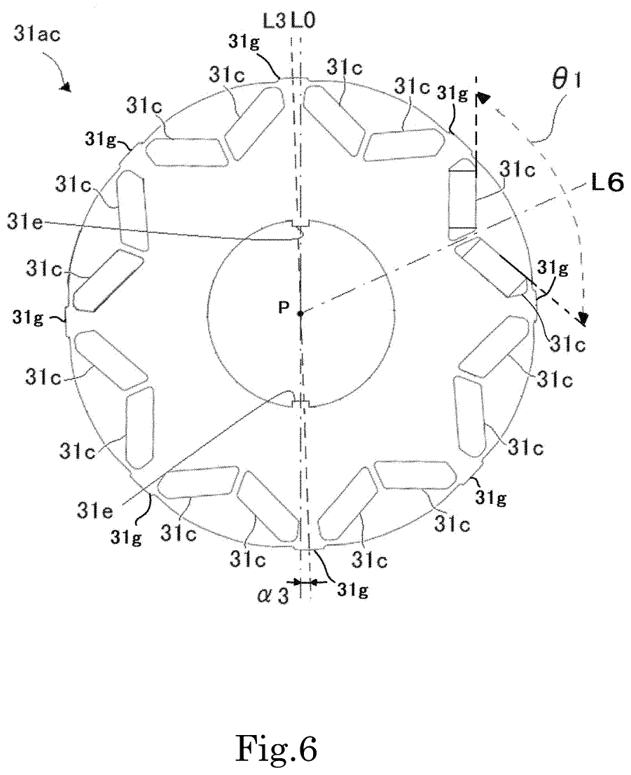

FIG. 6 is a cross-sectional view taken along a line C-C of the rotor core 31a in FIG. 3. A cross section of the third block 31ac will be described with reference to FIG. 6. In the third block 31ac, 16 magnet insertion hole portions 31c are provided, and two magnet insertion hole portions 31c form a pair. The pair of magnet insertion hole portions 31c are formed at equal intervals in the circumferential direction. That is, eight pairs of magnet insertion hole portions 31c are provided in the third block 31ac. The eight pairs of magnet insertion hole portions 31c are formed at equal intervals by 45 degrees in the circumferential direction. Note that, the third block 31ac is obtained by vertically inverting the first block 31aa.

Each magnet insertion hole portion 31c has a substantially parallelogram shape in plan view. An opposing distance of long sides of the pair of magnet insertion hole portions 31c sequentially increases toward the outside in the radial direction in plan view. Specifically, the pair of magnet insertion hole portions 31c are provided line-symmetrically about the virtual axis L6 extending in the radial direction from the center. The magnet insertion hole portion 31c is gradually inclined to the outside in the radial direction as a distance from the virtual axis L6 increases in the circumferential direction. Accordingly, the pair of magnet insertion hole portions 31c have a V shape as viewed from the axial direction.

The rotor magnets 31b are inserted into the magnet insertion hole portions 31c, respectively. The rotor magnets 31b are fixed to the third block 31ac by, for example, molding with resin. In the present embodiment, since there are eight pairs of magnet insertion hole portions 31c, there are also eight pairs of rotor magnets 31b. The eight pairs of rotor magnets 31b are arranged at equal intervals by 45 degrees in the circumferential direction.

In FIG. 6, the rotor magnets 31b are inserted into only some of the pair of magnet insertion hole portions 31c, but the rotor magnets 31b are inserted into all the magnet insertion hole portions 31c. In the pair of magnet insertion hole portions 31c, magnets having different polarities are inserted into the pair of magnet insertion hole portions 31c adjacent to each other in the circumferential direction. That is, rod-shaped magnets in which N poles and S poles are formed in the radial direction are alternately inserted into the pair of magnet insertion hole portions 31c. For example, rod-shaped magnets in which N poles are formed on the outside in the radial direction and S poles are formed on the inside in the radial direction are inserted into the pair of magnet insertion hole portions 31c through which the virtual axis L6 in FIG. 6 passes. Rod-shaped magnets in which S poles are formed on the outside in the radial direction and N poles are formed on the inside in the radial direction are inserted into the pair of magnet insertion hole portions 31c on both sides of the pair of magnet insertion hole portions 31c through which the virtual axis L6 in FIG. 6 passes.

Here, an angle formed by the pair of rotor magnets 31b arranged in the V shape is defined as a first magnet opening angle θ1. That is, the first magnet opening angle θ1 refers to an angle formed by long sides (long sides in the outside in the radial direction) of the pair of rotor magnets 31b inserted into the pair of magnet insertion hole portions 31c. Since the third block 31ac is formed by inverting the first block 31aa, the third block has the same first magnet opening angle θ1 as the first block 31aa.

Protrusion portions 31g are formed on an outer peripheral surface of the third block 31ac. A plurality of protrusion portions 31g are formed on the outside of the magnet insertion hole portions 31c in the radial direction. In the present embodiment, the protrusion portions 31g are provided at eight positions, and are provided between the pairs of magnet insertion hole portions 31c adjacent to each other. The eight protrusion portions 31g are provided at equal angular intervals in the circumferential direction.

Keys 31e protruding inward are provided on an inner peripheral surface of the third block 31ac. The key 31e has a rectangular shape. A plurality of keys 31e are provided. In the present embodiment, the keys 31e are provided at two positions. The two keys 31e are provided at equal angular intervals in the circumferential direction. In the third block 31ac, the center line L0, which passes through a center in a tangential direction of the two keys 31e and the axis P, and the center line L3, which passes through centers between the pair of magnet insertion hole portions 31c adjacent to the center line L0 and the pair of magnet insertion hole portions 31c adjacent to the pair of magnet insertion hole portions 31c adjacent to the center line L0 and passes through the axis P, are formed to be shifted in the circumferential direction at an angle α3. Note that, α3 is formed to be shifted from the first block 31aa by an angle α1 on an opposite side from the center line L0 in the circumferential direction.

The third block 31ac is inverted with the center line L0 of the first block 31aa as a center. Note that, in the present embodiment, the inversion means inversion by using the keys 31e. That is, grooves (not illustrated) extending in the axial direction are formed on an outer peripheral surface of the motor drive shaft 11 at equal angular intervals with the keys 31e. The positions of the blocks of the rotor core 31a are determined in the circumferential direction by inserting the keys 31e into the grooves extending in the axial direction of the motor drive shaft 11. At this time, the first block 31aa and the third block 31ac can be shifted in the circumferential direction by an angle α1 to one side in the circumferential direction and, further, by an angle α1 to the other side in the circumferential direction with respect to the second block 31ab, by vertically reversing (inverting) the blocks of the rotor core 31a having the same shape. However, the inversion may be performed as long as the arrangement of the first and third blocks and the arrangement of the rotor magnets 31b of the first block 31aa are line-symmetric about the center line, and the positions of the first and third blocks in the circumferential direction may be determined by means other than the keys 31e. For example, a block in which a key is not provided may be press-fitted into the motor drive shaft 11 by position determination means such as a jig. In this case, even though the third block 31ac is not inverted, the third block may be formed to be shifted by an angle of α1 to the opposite side from the first block 31aa with respect to the center line L0.

In the present embodiment, the rotor core 31a having a skew structure in which two types of blocks are integrally assembled in a state of being shifted in the circumferential direction by an angle α1 to one side in the circumferential direction and by an angle α1 to the other side in the circumferential direction with respect to the second block 31ab can be formed.

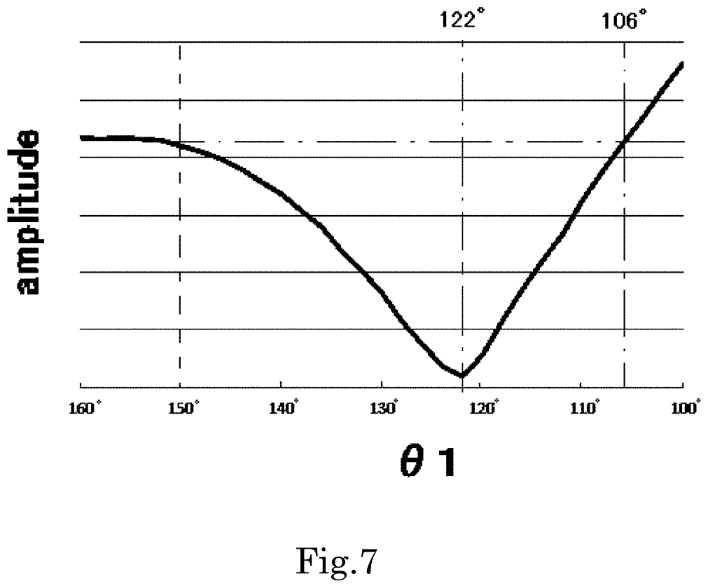

A skew angle is a shift in angle between centers of magnetic poles between the blocks. FIG. 7 is a graph illustrating an amplitude of a torque ripple of the motor body 30 when the skew angle α1 is set to 2°, the second magnet opening angle θ2 of the second block 31ab is set to 150°, and the first magnet opening angles θ1 of the first block 31aa and the third block 31ac are changed from 100° to 160°. A horizontal axis of the graph of FIG. 7 indicates the first magnet opening angle θ1, and a vertical axis of the graph indicates the amplitude of the torque ripple.

From the result of FIG. 7, the amplitude of the torque ripple is smaller when the first magnet opening angle θ1 is set to be less than 106° to 150° than when the second magnet opening angle θ2 of the second block 31ab is 150° and the first magnet opening angles θ1 of the first block 31aa and the third block 31ac are 150°. That is, the amplitude of the torque ripple is smaller than when the first magnet opening angle θ1 and the second magnet opening angle θ2 are equal. Note that, when the first magnet opening angles θ1 of the first block 31aa and the third block 31ac are set to 122°, the amplitude of the torque ripple becomes smallest. That is, the amplitude of the torque ripple can be reduced by setting the magnet opening angles of the first block 31aa and the second block 31ab to different angles.

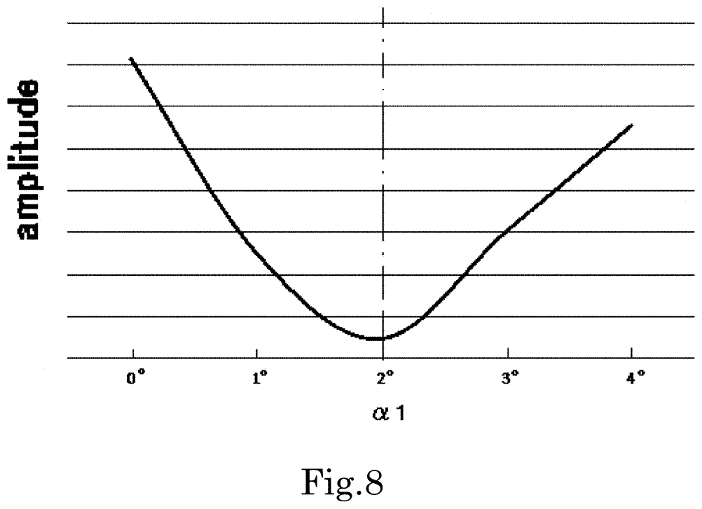

FIG. 8 is a graph illustrating an amplitude of the torque ripple caused by the change in the skew angle α1 when the second magnet opening angle θ2 of the second block 31ab is set to 150° and the first magnet opening angles θ1 of the first block 31aa and the third block 31ac are set to 122°. When the skew angle α1 is changed from 0° to 4°, the amplitude of the torque ripple is the smallest when the skew angle α1 is set to 2°.

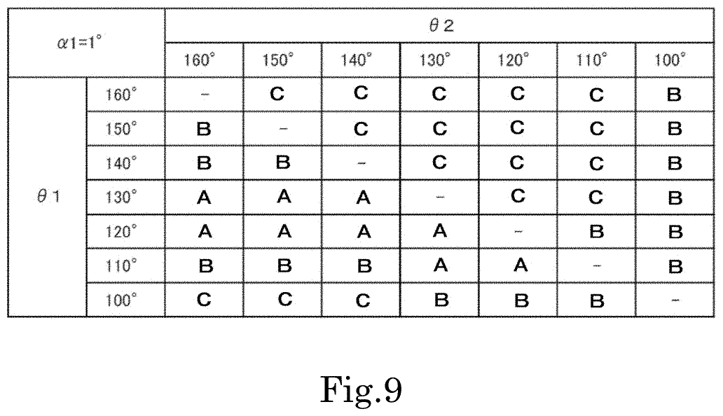

A table illustrated in FIG. 9 shows simulation results of the torque ripple when the first magnet opening angles θ1 of the first block 31aa and the third block 31ac are changed from 100° to 160° and the second magnet opening angle θ2 of the second block 31ab is changed from 100° to 160° when the skew angle α1 is set to 1°. C on the table indicates a case where the amplitude of the torque ripple becomes large or does not change as compared with a case where the first magnet opening angle θ1 and the second magnet opening angle θ2 are equal. B on the table indicates a case where the amplitude of the torque ripple becomes small as compared with a case where the first magnet opening angle θ1 and the second magnet opening angle θ2 are equal. A on the table indicates a case where the amplitude of the torque ripple becomes small as compared with a case where the first magnet opening angle θ1 and the second magnet opening angle θ2 are equal and further indicates a case where noise leaking to the outside of the housing due to the torque ripple is equal to or less than a criterion.

When the first magnet opening angle θ1 is 110° to 150° and the second magnet opening angle is 120° to 160° and when the angles of the first magnet opening angle θ1 and the second magnet opening angle θ2 are different from each other and the second magnet opening angle θ2 is larger than the first magnet opening angle θ1, values described in the table in FIG. 9 are A or B, and it can be seen that the torque ripple is improved as compared with a case where the first magnet opening angle θ1 and the second magnet opening angle θ2 are equal. In particular, when the first magnet opening angle θ1 is 120° to 130° and the second magnet opening angle θ2 is 130° to 160° and when the first magnet opening angle θ2 is larger than the first magnet opening angle θ1, the amplitude of the torque ripple is further suppressed, and the noise is also reduced. Note that, even when the first magnet opening angle θ1 is 110° and the second magnet opening angle θ2 is 120° to 130°, the amplitude of the torque ripple is suppressed and the noise is reduced.

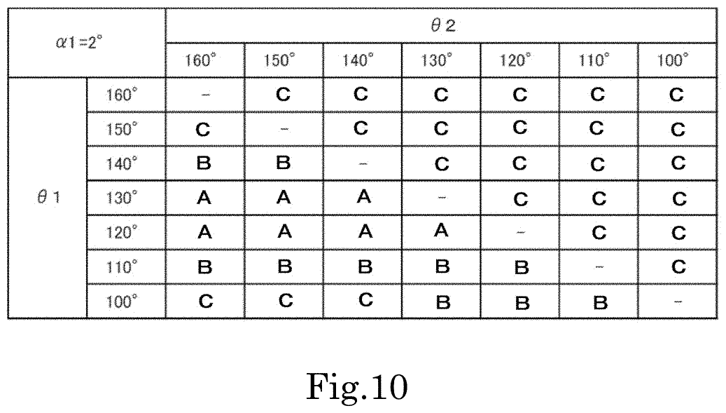

A table illustrated in FIG. 10 shows simulation results of the torque ripple when the first magnet opening angles θ1 of the first block 31aa and the third block 31ac are changed from 100° to 160° and the second magnet opening angle θ2 of the second block 31ab is changed from 100° to 160° when α1 as the skew angle is set to 2°. C on the table indicates a case where the amplitude of the torque ripple becomes large or does not change as compared with a case where the first magnet opening angle θ1 and the second magnet opening angle θ2 are equal. B on the table indicates a case where the amplitude of the torque ripple becomes small as compared with a case where the first magnet opening angle θ1 and the second magnet opening angle θ2 are equal. A on the table indicates a case where the amplitude of the torque ripple becomes small as compared with a case where the first magnet opening angle θ1 and the second magnet opening angle θ2 are equal and further indicates a case where noise leaking to the outside of the housing due to the torque ripple is equal to or less than a criterion.

When the first magnet opening angle θ1 is 110° to 140° and the second magnet opening angle is 120° to 160° and when the angles of the first magnet opening angle θ1 and the second magnet opening angle θ2 are different from each other and the second magnet opening angle θ2 is larger than the first magnet opening angle θ1, values described in the table in FIG. 9 are A or B, and it can be seen that the torque ripple is improved as compared with a case where the first magnet opening angle θ1 and the second magnet opening angle θ2 are equal. In particular, when the first magnet opening angle θ1 is 120° to 130° and the second magnet opening angle θ2 is 130° to 160° and when the first magnet opening angle θ2 is larger than the first magnet opening angle θ1, the amplitude of the torque ripple is further suppressed, and the noise is also reduced.

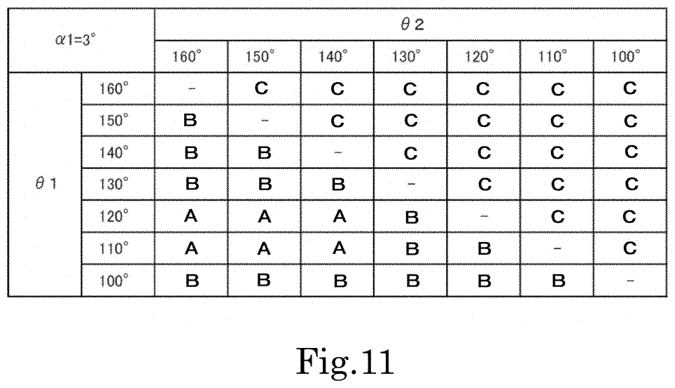

The table illustrated in FIG. 11 shows simulation results of the torque ripple when the first magnet opening angles θ1 of the first block 31aa and the third block 31ac are changed from 100° to 160° and the second magnet opening angle θ2 of the second block 31ab is changed from 100° to 160° when α1 as the skew angle is 3°. C on the table indicates a case where the amplitude of the torque ripple becomes large or does not change as compared with a case where the first magnet opening angle θ1 and the second magnet opening angle θ2 are equal. B on the table indicates a case where the amplitude of the torque ripple becomes small as compared with a case where the first magnet opening angle θ1 and the second magnet opening angle θ2 are equal. A on the table indicates that a case where the amplitude of the torque ripple becomes small as compared with a case where the first magnet opening angle θ1 and the second magnet opening angle θ2 are equal and further indicates a case where noise leaking to the outside of the housing due to the torque ripple is equal to or less than a criterion.

When the first magnet opening angle θ1 is 110° to 150° and the second magnet opening angle is 120° to 160° and when the angles of the first magnet opening angle θ1 and the second magnet opening angle θ2 are different from each other and the second magnet opening angle θ2 is larger than the first magnet opening angle θ1, values described in the table in FIG. 9 are A or B, and it can be seen that the torque ripple is improved as compared with a case where the first magnet opening angle θ1 and the second magnet opening angle θ2 are equal. In particular, when the first magnet opening angle θ1 is 120° to 130° and the second magnet opening angle θ2 is 130° to 160° and when the first magnet opening angle θ2 is larger than the first magnet opening angle θ1, the amplitude of the torque ripple is further suppressed, and the noise is also reduced.

In the present invention, the torque ripple can be reduced by setting the first magnet opening angle θ1 and the second magnet opening angle θ2 to different values. Since a concentration point of a magnetic force that causes the torque ripple on the outer peripheral surface of each of the first block 31aa, the second block 31ab, and the third block 31ac can be changed for each block by appropriately designing the first magnet opening angle θ1 and the second magnet opening angle θ2, the torque ripple can be reduced by changing a concentration portion of the magnetic force generated on the outer peripheral surface in each block and, thus, setting the first and second magnet opening angles so as to cancel the concentration point of the magnetic force that causes the torque ripple.

In the case of an 8-pole-pair motor, torque ripples of a 24-th component and a 48-th component often become a problem. It is more effective to set the first magnet opening angle θ1 to 120 degrees or 130 degrees and set the second magnet opening angle θ2 is set to be larger than the first magnet opening angle θ1 since the angles can be set so as to cancel the concentration points of the magnetic forces that causes 24-th and 48-th torque ripples.

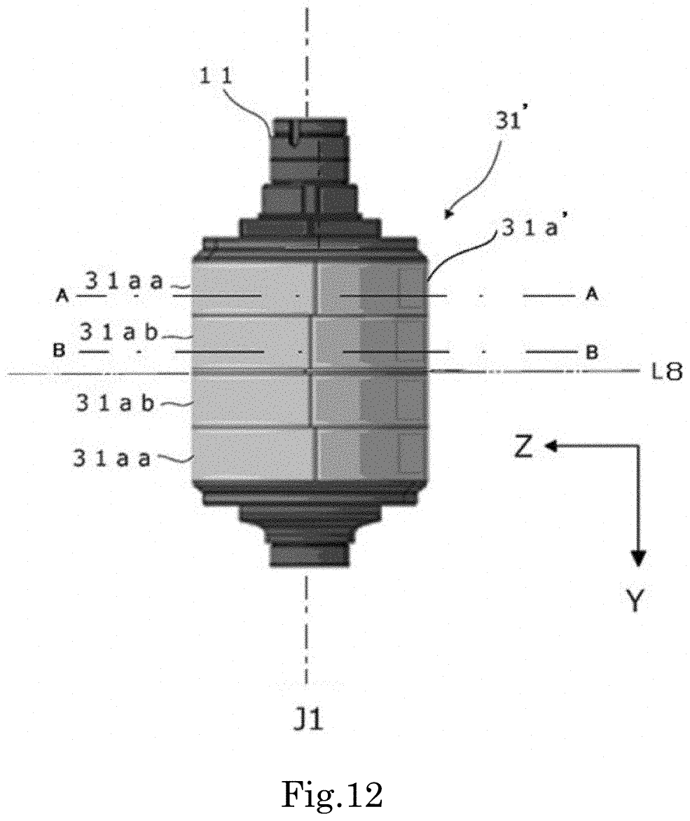

FIG. 12 illustrates another embodiment. A rotor core 31a′ illustrated in FIG. 12 is formed by stacking a plurality of electromagnetic steel sheets. The rotor core 31a′ is divided into four blocks (first block 31aa, first block 31aa, second block 31ab, and second block 31ab) having the same thickness dimension, and the first block 31aa, the second block 31ab, the second block 31ab, and the first block 31aa are stacked in this order from the −Y side. That is, the rotor core 31a′ has a shape inverted around the imaginary line L8. In another embodiment, the first block 31aa is similar to the first block shown in FIG. 4. The second block 31ab is similar to the second block shown in FIG. 5. In another embodiment, the first block 31aa and the second block 31ab have a so-called skew structure in which these blocks are integrally assembled in a state of being shifted at an angle of α1 in the circumferential direction.

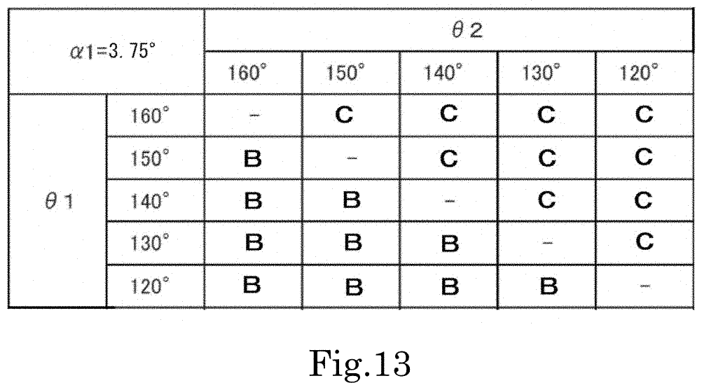

The table illustrated in FIG. 13 shows simulation results of the torque ripple when the first magnet opening angle θ1 of the first block 31aa is changed from 120° to 160° and the second magnet opening angle θ2 of the second block 31ab is changed from 120° to 160° when α1 as a skew angle of the rotor core 31a′ is 3.75°. C on the table indicates a case where the amplitude of the torque ripple becomes large or does not change as compared with a case where the first magnet opening angle θ1 and the second magnet opening angle θ2 are equal. B on the table indicates a case where the amplitude of the torque ripple becomes small as compared with a case where the first magnet opening angle θ1 and the second magnet opening angle θ2 are equal. When the first magnet opening angle θ1 is 120° to 160° and the second magnet opening angle is 120° to 160° and when the first magnet opening angle θ1 and the second magnet opening angle θ2 are different from each other and the second magnet opening angle θ2 is larger than the first magnet opening angle θ1, it can be confirmed that the torque ripple is improved as compared with a case where the first magnet opening angle θ1 and the second magnet opening angle θ2 are equal.

Although the embodiments of the present invention have been described above, a combination of the configurations in the embodiments is merely an example, and therefore addition, omission, substation and other alterations may be appropriately made within the scope of the present invention. In addition, note that, the present invention is not limited by the embodiment.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A motor comprising:
a rotor that includes a rotor core formed by stacking a plurality of electromagnetic steel sheets and a plurality of rotor magnets, and is rotatable about a center axis extending in an upper-lower direction; and
a stator that surrounds the rotor from an outside of the center axis in a radial direction,
wherein
the rotor core includes a plurality of pairs of magnet insertion hole portions arranged such that an opposing distance sequentially increases toward the outside in the radial direction as viewed in an axial direction,
the plurality of rotor magnets are positioned in the magnet insertion hole portions,
the rotor core includes first blocks arranged by dividing the rotor core into two blocks in the axial direction, and a second block arranged between the two first blocks, and
when an angle formed by the rotor magnets in the pair of magnet insertion hole portions in the first block is defined as a first magnet opening angle θ1 and an angle formed by the rotor magnets in the pair of magnet insertion hole portions in the second block is defined as a second magnet opening angle θ2, the second magnet opening angle θ2 is larger than the first magnet opening angle θ1.

2. The motor according to claim 1, wherein a skew angle formed by the first block and the second block is 1° to 3°.

3. The motor according to claim 2, wherein
when the skew angle is 1°,
the first magnet opening angle is 110° to 150°, and the second magnet opening angle is 120° to 160°.

4. The motor according to claim 2, wherein
when the skew angle is 2°,
the first magnet opening angle is 110° to 140°, and the second magnet opening angle is 120° to 160°.

5. The motor according to claim 2, wherein
when the skew angle is 3°,
the first magnet opening angle is 110° to 150°, and the second magnet opening angle is 120° to 160°.

6. The motor according to claim 1, wherein
the rotor includes
second blocks arranged by dividing the rotor into two blocks in the axial direction, and
a third block arranged between the two second blocks, and
an angle formed by the rotor magnets in the pair of magnet insertion hole portions in the third block is an angle similar to the first magnet opening angle θ1 of the first block.

7. The motor according to claim 6, wherein
two keys protruding inward are provided on an inner peripheral surface of the third block at equal angular intervals in a circumferential direction, and
the third block is formed by inverting the first block with respect to a center line passing through a center in a tangential direction of the two keys and an axis.

8. The motor according to claim 6 or 7, wherein the first blocks, the second blocks, and the third blocks are stacked in order of the first block, the second block, the third block, the third block, the second block, and the first block from one side to the other side in the axial direction.

9. A motor unit comprising:
a motor drive shaft fixed to the rotor of the motor according to claim 1; and
a transmission mechanism connected to the motor drive shaft.
